(19) United States
(12) Patent Application Publication
(10) Pub. No.: US 2002/0110319 A1
(43) Pub. Date: Aug. 15, 2002

(54) Optical fiber having decorative effect

(76) Inventor: Yin-Su Chung, Yun Lin Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/782,147

(22) Filed: Feb. 14, 2001

(51) Int. Cl. G02B 6/26

(52) U.S. Cl. 385/31; 385/43; 385/901

(57) ABSTRACT

An optical fiber has a decorative effect and is capable of guiding a light source from an incident end thereof toward an output end thereof such that the light source is illuminated multidirectionally from the output end.

### FIELD OF THE INVENTION

The present invention relates generally to an optical fiber, and more particularly to an optical fiber for ornamental purpose.

### BACKGROUND OF THE INVENTION

As shown in FIG. 1, a light ray is introduced into an optical fiber head (not shown in the drawing) such that the light ray L is encountered with the wall surface 1 of the optical fiber, thereby resulting in transmission of the light ray L toward the tail end 2 of the optical fiber. The light is then emitted at the tail end 2 of the optical fiber. The light ray L can be emitted from the optical fiber tail end 2 in view of the fact that the transmission direction of the light ray L forms an angle of 90 degrees along with the cross section 2a of the optical fiber tail end 2. As a result, the optical fiber tail end is illuminated. When an incident angle takes place in the course of the light ray transmission, the light ray L is reflected back at the same angle of reflection. The illuminated range is the size of the area of the cross section 2a of the optical fiber tail end 2. The illumination effect depends on the cross-sectional area of the optical fiber.

### SUMMARY OF THE INVENTION

The primary objective of the present invention is to provide an optical fiber with an output end capable of a better illumination.

It is another objective of the present invention to provide an optical fiber with an output end which is so patterned as to bring about a decorative effect.

The optical fiber of the present invention has an incident end and an output end. The light source moves into the incident end to bring about an illumination at the output end. The illumination takes place in various directions to enhance the decorative effect of the output end.

The output end of an optical fiber has a better illumination effect if at least one linear diameter of the output end has a width greater than the width of the linear diameter of the main body of the optical fiber.

### BRIEF DESCRIPTION OF THE DRAWINGS

FIG. 1 shows a schematic view of the light transmittance of a conventional optical fiber.

FIG. 2 shows a schematic view of a first pattern of a preferred embodiment of the present invention.

FIG. 3 shows a schematic view of a second pattern of the preferred embodiment of the present invention.

FIG. 4 shows a schematic view of a third pattern of the preferred embodiment of the present invention.

FIG. 5 shows a schematic view of a fourth pattern of the preferred embodiment of the present invention.

FIG. 6 shows a schematic view of a figured output end of an optical fiber of the present invention.

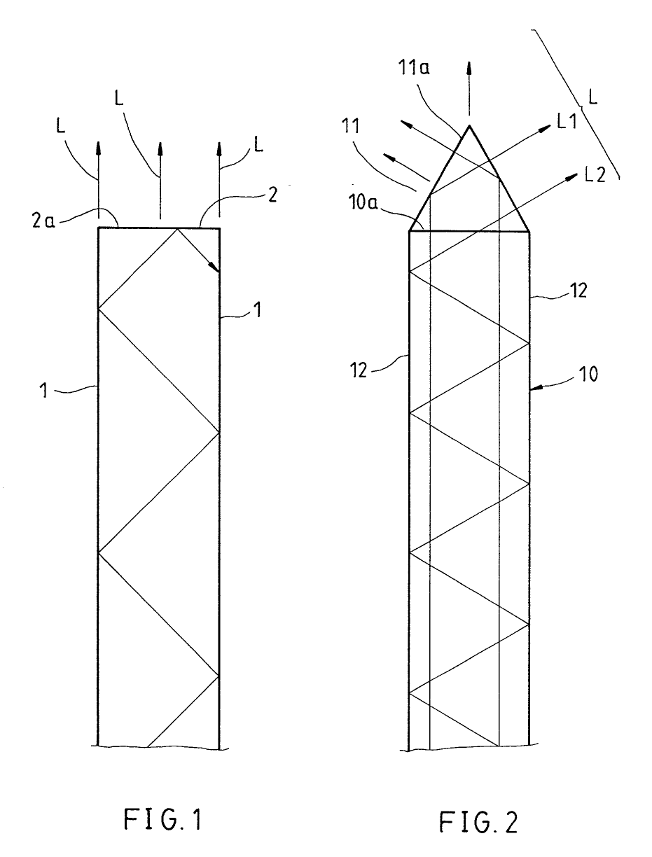

### DETAILED DESCRIPTION OF THE INVENTION

As shown in FIG. 2, an optical fiber 10 of the present invention has an incident end (not shown in the drawing) and an output end 11. A light ray L is introduced into the optical fiber 10 from the incident end such that the light ray L is emitted at the output end 11 which is of a tapered construction. The tapered output end 11 has one side 11a forming an angle of 60 degrees along with the cross-sectional surface 10a of the turning point of the main body of the optical fiber 10. Regardless of the direction in which the transmittance of the light ray L takes place, the light ray is emitted as light ray L1 and light ray L2, as long as the forward direction of the light ray L forms an angle of 90 degrees along with the side 11a. As the light ray L1 is encountered with the tapered side 11a, the light ray L1 is reflected to form an angle of 90 degrees along with other tapered side 11a. This is due to the fact that the incident angle (30 degrees) is equal to the angle of reflection (30 degrees). The light ray L2 is encountered with the side wall 12 of the optical fiber 10 at an incident angle of 60 degrees. The light ray L2 is emitted at an angle of 90 degrees, which is formed by the reflection direction and the tapered side 11a. The light ray is emitted in various directions from the tapered output end 11, thereby resulting in an enhanced effect of illumination.

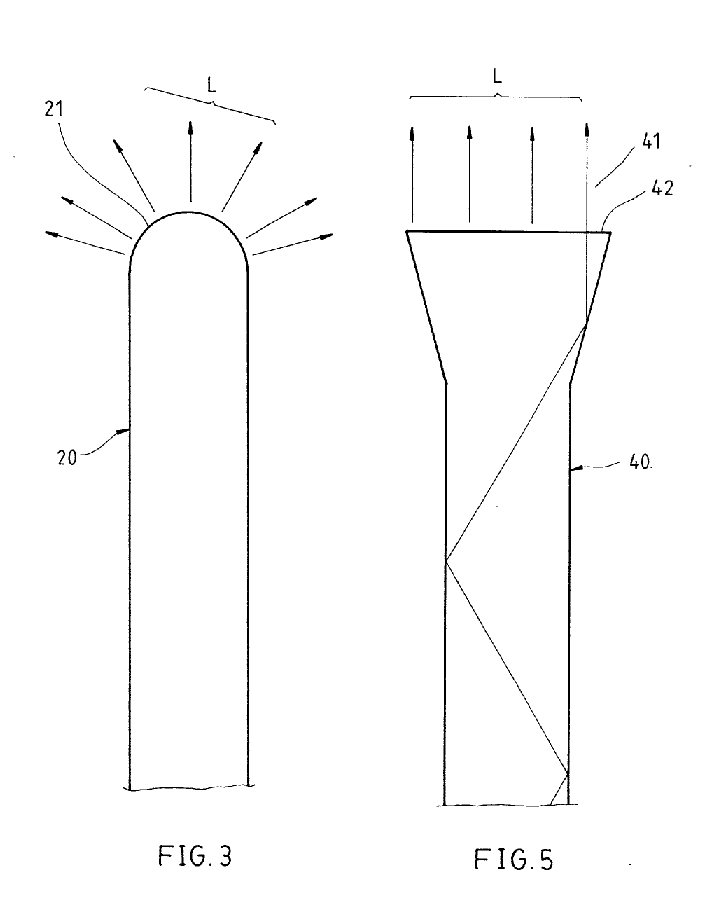

As shown in FIG. 3, the optical fiber 20 has a semispherical output end 21. When the light ray is reflected repeatedly, the forward direction of some portion of the light ray forms an angle of 90 degrees along with the tangent direction of one of the points on the output end 21. The light ray L is illuminated at the semispherical output end 21 in different directions, thereby resulting in a better illumination effect capable of illuminating an expanded area.

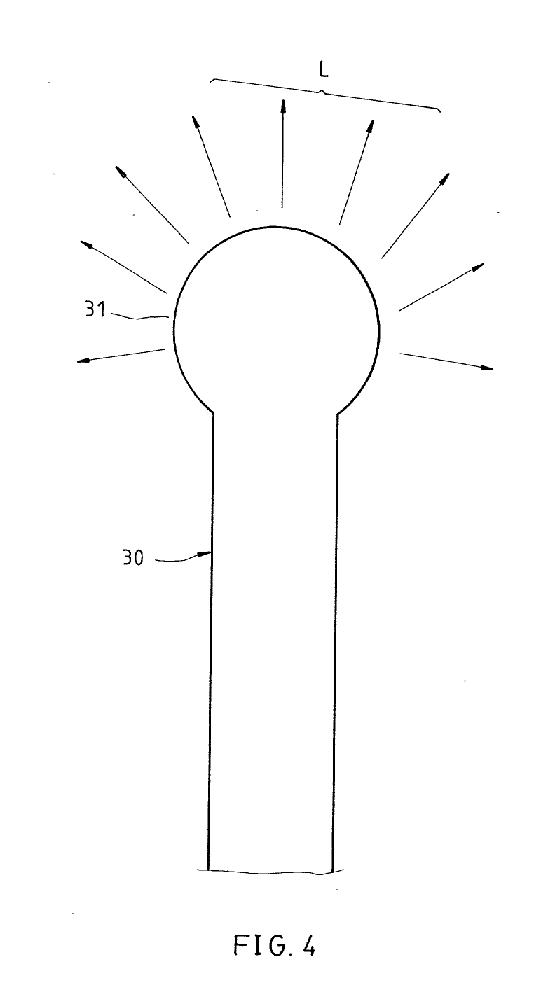

As shown in FIG. 4, the optical fiber 30 has an incident end (not shown in the drawing) and an output end 31 which is of a spherical construction. The width of at least one linear diameter of the spherical output end is greater than the width of the linear diameter of the main body of the optical fiber 30. As the light ray L is introduced into the spherical output end 31, the light ray is reflected before the light ray is emitted at the most optimum transmittance angle. As a result, the entire surface of the spherical output end 31 is brightly illuminated.

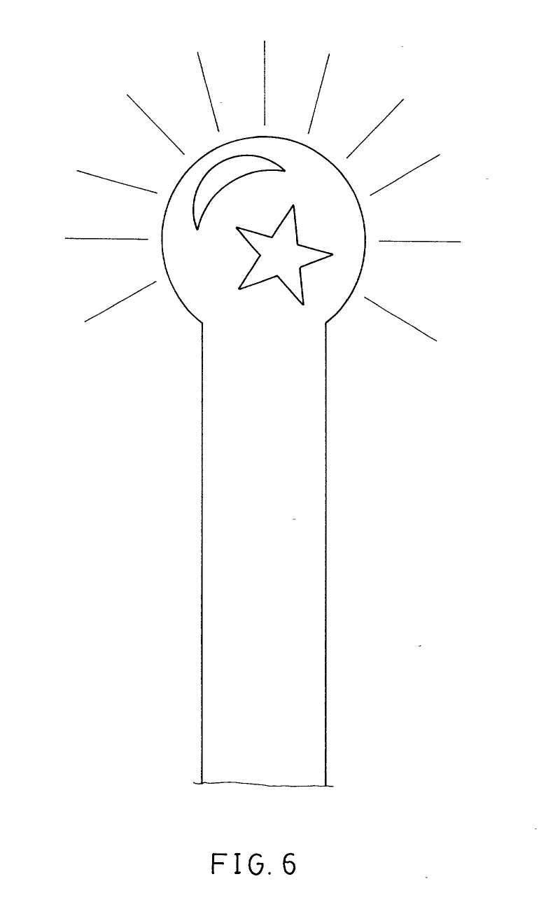

As shown in FIG. 5, an optical fiber 40 of the present invention has a tapered output end 41 which is gradually expanded toward the outer end. The outer end is provided with a flat smooth face 42 of an area greater than the cross-sectional area of the main body of the optical fiber 40. When the light ray enters the output end 41 in different paths, portion of the light ray is reflected and is then emitted vertically from the flat smooth face 42. As a result, the face 42 is well illuminated.

As shown in FIG. 6, the output end of the optical fiber of the present invention is patterned to enhance the decorative effect of the output end.

What is claimed is:

1. An optical fiber capable of guiding a light source from an incident end thereof toward an output end thereof in such a manner that the light source is illuminated in various directions from said output end.

2. The optical fiber as defined in claim 1, wherein said output end is of a tapered construction and becomes gradually smaller in diameter toward an outer end thereof.

3. The optical fiber as defined in claim 2, wherein the tapered side of said output end forms an angle of 60 degrees along with a cross-sectional face of the junction of the main body of said optical fiber.

4. The optical fiber as defined in claim 1, wherein said output end is of a semispherical construction.

5. The optical fiber as defined in claim 1, wherein said output end is patterned.

6. An optical fiber capable of guiding a light source from an incident end thereof toward an output end thereof in such a manner that the light source is illuminated from said output end whereby said output end has at least one linear diameter with a width greater than a width of the linear diameter of the main body of the optical fiber.

7. The optical fiber as defined in claim 6, wherein said output end is of a spherical construction.

8. The optical fiber as defined in claim 6, wherein said output end is of a tapered construction and becomes gradually larger in diameter toward an outer end thereof.

9. The optical fiber as defined in claim 6, wherein said output end is patterned.
